(19) United States
(12) Patent Application Publication
(10) Pub. No.: US 2012/0323971 A1
(43) Pub. Date: Dec. 20, 2012

(54) OPTIMIZING DATA STORAGE AND ACCESS OF AN IN-MEMORY DATABASE

(75) Inventor: Kantikiran Krishna PASUPULETI, Visakhapatnam (IN)

(73) Assignee: SYBASE, INC., Dublin, CA (US)

(21) Appl. No.: 13/160,123

(22) Filed: Jun. 14, 2011

(51) Int. Cl. G06F 17/30

(52) U.S. Cl. 707/802; 707/E17.055

(57) ABSTRACT

System, method, computer program product embodiments and combinations and sub-combinations thereof are provided for optimizing data storage and access of an in-memory database in a database management system. Embodiments include utilizing in-memory storage for hosting an entire database, and storing objects of the database individually in separate portions of the in-memory storage, wherein a portion size is based upon an object element size.

### BACKGROUND

1. Field of the Invention

The present invention relates to database management systems and, more particularly, to a system and methodology for optimizing data storage and access of an in-memory database.

2. Background Art

Computers are very powerful tools for storing and providing access to vast amounts of information. Computer databases are a common mechanism for storing information on computer systems while providing easy access to users. A typical database is an organized collection of related information stored as “records” having “fields” of information. As an example, a database of employees may have a record for each employee where each record contains fields designating specifics about the employee, such as name, home address, salary, and the like.

Between the actual physical database itself (i.e., the data actually stored on a storage device) and the users of the system, a database management system or DBMS is typically provided as a software cushion or layer. In essence, the DBMS shields the database user from knowing or even caring about the underlying hardware-level details. Typically, all requests from users for access to the data are processed by the DBMS. For example, information may be added or removed from data files, information retrieved from or updated in such files, and so forth, all without user knowledge of the underlying system implementation. In this manner, the DBMS provides users with a conceptual view of the database that is removed from the hardware level. The general construction and operation of database management systems is well known in the art. See e.g., Date, C., “An Introduction to Database Systems, Seventh Edition”, Part I (especially Chapters 1-4), Addison Wesley, 2000.

In operation, a DBMS frequently needs to retrieve data from or persist data to storage devices such as disks. Unfortunately, access to such storage devices can be somewhat slow. To speed up access to data, databases typically employ a “cache” or “buffer cache” which is a section of relatively faster memory (e.g., random access memory (RAM)) allocated to store recently used data objects. Throughout the remainder of the specification, this faster memory will simply be referred to as “memory,” as distinguished from mass storage devices such as disks. Memory is typically provided on semiconductor or other electrical storage media and is coupled to a CPU (central processing unit) via a fast data bus which enables data maintained in memory to be accessed more rapidly than data stored on disks.

As memory provided on computer systems has a limited size, some method must be employed for managing what content is maintained in cache memory. Conventionally, data storage systems employ some form of a “least recently used-most recently used” (LRU/MRU) protocol to queue data objects in the buffer cache. Basically, such LRU/MRU protocol moves the “most recently used” data object to the head of the queue while simultaneously moving data objects that have not been used one step towards the end of the queue. Thus, infrequently used objects migrate toward the end of the queue, and ultimately are deleted from the buffer cache to make room for new data objects copied from disks (i.e., infrequently used objects are displaced by more recently used objects). In this manner, the most recently used data objects are the only objects stored in the buffer cache at any given time.

Unfortunately, the basic LRU/MRU memory management protocol is subject to a number of limitations. As a result, other approaches providing for greater efficiency in management of data objects in cache have been adopted. For example, U.S. Pat. No. 6,061,763 provides for partitioning computer memory provided in a single cache, symmetric multiprocessor (SMP) system into a plurality of buffer caches to improve LRU/MRU operations. Although this approach provides considerable performance improvements over the basic LRU/MRU protocol for a disk-based DBMS, problems remain in providing fast access to data in database systems.

Among the issues being addressed by current database management system solutions is the fact that these existing solutions are not designed to support the running of an entire database fully in-memory without any on-disk storage and integrated tightly with the database server engine. Some software components, such as SolidDB from IBM Corporation (Armonk, N.Y.) or TimesTen from Oracle Corporation (Redwood City, Calif.), are available to provide some level of support of an in-memory database, but these are stand-alone products operating as an add-on to the operations of the database server and are not integrated within the database server engine.

In order to obtain better performance in a database system environment, the ability to integrate support for a zero-disk footprint in-memory database in a database server is being pursued. For example, co-pending U.S. patent application Ser. No. 12/726,063, filed Mar. 17, 2010, entitled “Managing Data Storage as an In-memory Database in a Database Management System” (attorney docket 10176-US), and assigned to the assignee of the present invention, describes an approach to provide this support without any other external software components or other operating system support. While achieving a significant advance through this approach, it utilizes data storage that reflects a page-based model that has commonly been employed by disk-based database systems. As is generally understood, in a page-based model, all data is stored in pages (traditionally, on a secondary storage device, usually a hard disk). Typically, these pages may range in size from 1 Kb to 32 Kb, with the most common page sizes being 2 Kb and 4 Kb. All input/output operations (I/O) are done in page-sized units—that is, the entire page is read/written at once. Pages are also allocated for one purpose at a time: a database page may be used to store table data or used for virtual memory, but it will not be used for both.

With the advance to an in-memory database in a DBMS, a need exists to provide an approach to data storage and access that takes better advantage of the in-memory nature of database hosting and without the limitations associated with a disk-based model. The present invention provides a solution for these and other needs.

### BRIEF SUMMARY

Briefly stated, the invention includes system, method, computer program product embodiments and combinations and sub-combinations thereof for optimizing data storage and access of an in-memory database in a database management system. Embodiments include utilizing in-memory storage for hosting an entire database, and storing objects of the database individually in separate portions of the in-memory storage, wherein a portion size is based upon an object element size. Further embodiments, features, and advantages of the invention, as well as the structure and operation of the various embodiments of the invention, are described in detail below with reference to accompanying drawings.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 illustrates a general block diagram of a computer system (e.g., an IBM-compatible system) in which software-implemented processes of the present invention may be embodied.

FIG. 2 illustrates the general structure of a client/server database system suitable for implementing the present invention.

FIG. 3 illustrates a block diagram of an overall approach for optimizing data storage utilization of an in-memory database in a database management system in accordance with embodiments of the invention.

FIG. 4 illustrates an example block diagram representation of a data cache organized in accordance with an embodiment of the invention.

FIG. 5 illustrates an example block diagram representation of all portions allocated to a particular object, including some having free space, in accordance with an embodiment of the invention.

FIG. 6 illustrates an example block diagram representation of portions having variable data in accordance with an embodiment of the invention.

FIG. 7 illustrates an example representation of a row in accordance with an embodiment of the invention.

FIG. 8 illustrates an example block diagram representation of portions having row versions in accordance with an embodiment of the invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION

The present invention relates to a system, method, computer program product embodiments and combinations and sub-combinations thereof for providing methodology for optimizing data storage and access of an in-memory database in a database management system.

### GLOSSARY

The following definitions are offered for purposes of illustration, not limitation, in order to assist with understanding the discussion that follows.

Cache: a cache is a section of relatively faster memory (e.g., RAM) allocated to temporarily store data objects so as to provide faster access to such objects (e.g., when compared to access of such objects from disk).

Relational database: A relational database is a collection of data items organized as a set of formally-described tables from which data can be accessed or reassembled in many different ways without having to reorganize the database tables. The relational database was invented by E. F. Codd at IBM in 1970. A relational database employs a set of tables containing data fitted into predefined categories. Each table (which is sometimes called a relation) contains one or more data categories in columns. The standard user and application program interface to a relational database is the structured query language (SQL), defined below.

SMP: SMP stands for symmetric multi-processing system, which is a system comprised of multiple processors (CPUs) and a single RAM memory, which has a single instance of the operating system (O/S) running on it. All the CPUs serve and run all the functionality of the O/S and application symmetrically.

SQL: SQL stands for Structured Query Language. The original version called SEQUEL (structured English query language) was designed by IBM in the 1970's. SQL-92 (or SQL/92) is the formal standard for SQL as set out in a document published by the American National Standards Institute in 1992; see e.g., “Information Technology—Database languages—SQL”, published by the American National Standards Institute as American National Standard ANSI/ISO/IEC 9075: 1992, the disclosure of which is hereby incorporated by reference. SQL-92 was superseded by SQL-99 (or SQL3) in 1999; see e.g., “Information Technology—Database Languages—SQL, Parts 1-5” published by the American National Standards Institute as American National Standard INCITS/ISO/IEC 9075-(1-5)-1999 (formerly ANSI/ISO/IEC 9075-(1-5)1999), the disclosure of which is hereby incorporated by reference.

IMDB: In-Memory database, a zero-disk footprint database which is hosted entirely in-memory in the buffer cache. No disk device is required to create and use such a database.

In-memory Storage Cache: a named cache in an IMDB with a specified cache type (e.g., ‘inmemory_storage’) being used to host the entire database, and effectively turning off I/O to disk during run-time operations of the server. Other buffer manager strategies like buffer grabbing, washing and replacement are also turned off for an in-memory storage cache.

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

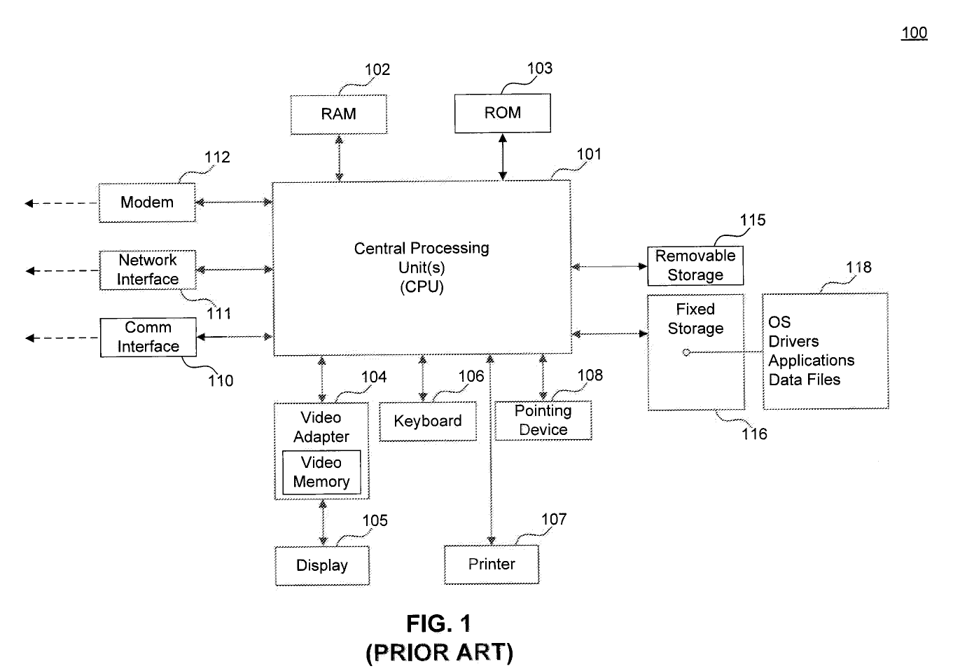

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. RAM 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files 118, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, a HP Laserjet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows’ implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

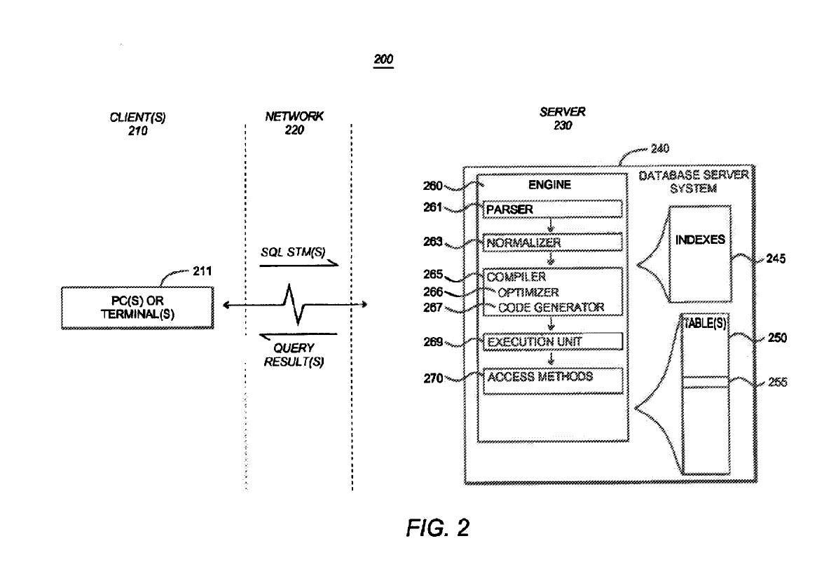

While the present invention may operate within a single (standalone) computer (e.g., system 100 of FIG. 1), the present invention is preferably embodied in a multi-user computer system, such as a client/server system. FIG. 2 illustrates the general structure of a client/server database system 200 suitable for implementing the present invention. As shown, the system 200 comprises one or more client(s) 210 connected to a server 230 via a network 220. Specifically, the client(s) 210 comprise one or more standalone terminals 211 connected to a database server system 240 using a conventional network. In an exemplary embodiment, the terminals 211 may themselves comprise a plurality of standalone workstations, dumb terminals, or the like, or comprise personal computers (PCs) such as the above-described system 100. Typically, such units would operate under a client operating system, such as a Miciosoft.RTM. Windows client operating system (e.g., Microsoft.RTM. Windows 95/98, Windows 2000, or Windows XP).

The database server system 240, which comprises Sybase.RTM. Adaptive Server.RTM. Enterprise (ASE, available from Sybase, Inc. of Dublin, Calif.) in an exemplary embodiment, generally operates as an independent process (i.e., independently of the clients), running under a server operating system such as Microsoft.RTM. Windows NT, Windows 2000, or Windows XP (all from Microsoft Corporation of Redmond, Wash.), UNIX (Novell), Solaris (Sun), or Linux (Red Hat). The network 220 may be any one of a number of conventional network systems, including a Local Area Network (LAN) or Wide Area Network (WAN), as is known in the art (e.g., using Ethernet, IBM Token Ring, or the like). The network 220 includes functionality for packaging client calls in the well-known Structured Query Language (SQL) together with any parameter information into a format (of one or more packets) suitable for transmission to the database server system 240.

Client/server environments, database servers, and networks are well documented in the technical, trade, and patent literature. For a discussion of Sybase.RTM.-branded database servers and client/server environments generally, see, e.g., Nath, A., “The Guide to SQL Server”, Second Edition, Addison-Wesley Publishing Company, 1995. For a description of Sybase.RTM. Adaptive Server.RTM. Enterprise (ASE), see, e.g., “Adaptive Server Enterprise 15.0” documentation set from Sybase, Inc. of Dublin, Calif. This product documentation is available via the Internet (e.g., currently at sybooks.sybase.com/). The disclosures of the foregoing are hereby incorporated by reference.

The above-described computer hardware and software are presented for purposes of illustrating the basic underlying desktop and server computer components that may be employed for implementing the present invention. The present invention, however, is not limited to any particular environment or device configuration. Instead, the present invention may be implemented in any type of system architecture or processing environment capable of supporting the methodologies of the present invention presented in detail below.

In operation, the client(s) 210 store data in, or retrieve data from, one or more database tables 250, as shown at FIG. 2. Data in a relational database is stored as a serves of tables, also called relations. Typically resident on the server 230, each table itself comprises one or more “rows” or “records” (tuples) (e.g., row 255 as shown at FIG. 2). A typical database will contain many tables, each of which stores information about a particular type of entity. A table in a typical relational database may contain anywhere from a few rows to millions of rows. A row is divided into fields or columns; each field represents one particular attribute of the given row. A row corresponding to an employee record, for example, may include information about the employee's ID Number, Last Name and First Initial, Position, Date Hired, Social Security Number, and Salary. Each of these categories, in turn, represents a database field. In the foregoing employee table, for example, Position is one field, Date Hired is another, and so on. With this format, tables are easy for users to understand and use. Moreover, the flexibility of tables permits a user to define relationships between various items of data, as needed. Thus, a typical record includes several categories of information about an individual person, place, or thing. Each row in a table is uniquely identified by a record ID (RID), which can be used as a pointer to a given row.

Most relational databases implement a variant of the Structured Query Language (SQL), which is a language allowing users and administrators to create, manipulate, and access data stored in the database. The syntax of SQL is well documented; see, e.g., the above-mentioned “An Introduction to Database Systems”. SQL statements may be divided into two categories: data manipulation language (DML), used to read and write data; and data definition language (DDL), used to describe data and maintain the database. DML statements are also called queries. In operation, for example, the clients 210 issue one or more SQL commands to the server 230. SQL commands may specify, for instance, a query for retrieving particular data (i.e., data records meeting the query condition) from the database table(s) 250. In addition to retrieving the data from database server table(s) 250, the clients 210 also have the ability to issue commands to insert new rows of data records into the table(s), or to update and/or delete existing records in the table(s).

SQL statements or simply “queries” must be parsed to determine an access plan (also known as “execution plan” or “query plan”) to satisfy a given query. In operation, the SQL statements received from the client(s) 210 (via network 220) are processed by the engine 260 of the database server system 240. The engine 260 itself comprises a parser 261, a normalizer 263, a compiler 265, an execution unit 269, and access methods 270. Specifically, the SQL statements are passed to the parser 261 which converts the statements into a query tree—a binary tree data structure which represents the components of the query in a format selected for the convenience of the system. In this regard, the parser 261 employs conventional parsing methodology (e.g., recursive descent parsing).

The query tree is normalized by the normalizer 263. Normalization includes, tor example, the elimination of redundant data. Additionally, the normalizer 263 performs error checking, such as confirming that table names and column names which appear in the query are valid (e.g., are available and belong together). Finally, the normalizer 263 can also look-up any referential integrity constraints which exist and add those to the query.

After normalization, the query tree is passed to the compiler 265, which includes an optimizer 266 and a code generator 267. The optimizer 266 is responsible for optimizing the query tree. The optimizer 266 performs a cost-based analysis for formulating a query execution plan. The optimizer will, for instance, select the join order of tables (e.g., when working with more than one table), and will select relevant indexes (e.g., when indexes are available). The optimizer, therefore, performs an analysis of the query and selects the best execution plan, which in turn results in particular access methods being invoked during query execution. It is possible that a given query may be answered by tens of thousands of access plans with widely varying cost characteristics. Therefore, the optimizer must efficiently select an access plan that is reasonably close to an optimal plan. The code generator 267 translates the query execution plan selected by the query optimizer 266 into executable form for execution by the execution unit 269 using the access methods 270.

For enhancing the storage, retrieval, and processing of data records, the server 230 maintains one or more database indexes 245 on the database tables 250. Indexes 245 can be created on columns or groups of columns in a table. Such an index allows the page containing rows that match a certain condition imposed on the index columns to be quickly located on disk, rather than requiring the engine to scan all pages in a table to find rows that fulfill some property, thus facilitating quick access to the data records of interest. Indexes are especially useful when satisfying equality and range predicates in queries (e.g., a column is greater than or equal to a value) and “order by” clauses (e.g., show all results in alphabetical order by a given column).

A database index allows the records of a table to be organized in many different ways, depending on a particular user's needs. An index key value is a data quantity composed of one or more fields from a record which are used to arrange (logically) the database file records by some desired order (index expression). Here, the column or columns on which an index is created form the key for that index. An index may be constructed as a single disk file storing index key values together with unique record numbers. The record numbers are unique pointers to the actual storage location of each record in the database file.

Indexes are usually implemented as multi-level tree structures, typically maintained as a B-Tree data structure. Pointers to rows are usually stored in the leaf nodes of the tree, so an index scan may entail reading several pages before reaching the row. In some cases, a leaf node may contain the data record itself. Depending on the data being indexed and the nature of the data being stored, a given key may or may not be intrinsically unique. A key that is not intrinsically unique can be made unique by appending a RID. This is done for all non-unique indexes to simplify the code for index access. The traversal of an index in search of a particular row is called a probe of the index. The traversal of an index in search of a group of rows fulfilling some condition is called a scan of the index. Index scans frequently look for rows fulfilling equality or inequality conditions; for example, an index scan would be used to find all rows that begin with the letter ‘A’

Heretofore, all data in a typical relational database system is stored in pages on a secondary storage device, usually a hard disk. Typically, these pages may range in size from 1 Kb to 32 Kb, with the most common page sizes being 2 Kb and 4 Kb. All input/output operations (I/O) against secondary storage are done in page-sized units—that is, the entire page is read/written at once. Pages are also allocated for one purpose at a time: a database page may be used to store table data or used for virtual memory, but it will not be used for both. The memory in which pages that have been read from disk reside is called the cache or buffer pool.

I/O to and from the disk tends to be the most costly operation in executing a query. This is due to the latency associated with the physical media, in comparison with the relatively low latency of main memory (e.g., RAM). Query performance can thus be increased by reducing the number of I/O operations that must be completed. An additional consideration with respect to I/O is whether it is sequential or random. Due to the construction of hard disks, sequential I/O is much faster then random access I/O. Data structures and algorithms encouraging the use of sequential I/O can realize greater performance. In typical implementations, this can be done by using data structures and algorithms that maximize the use of pages that are known to reside in the cache or by being more selective about what pages are loaded into the cache in the first place.

As mentioned previously, these existing solutions are not designed to support the running of an entire database fully in-memory without any on-disk storage and integrated with the database server. While the aforementioned “Managing Data Storage as an In-memory Database in a Database Management System” provides an in-memory database created entirely in a named cache, without any on-disk storage, its approach to data storage reflects a page-based model that has commonly been employed by disk-based database systems.

The present invention provides an approach to data management storage and access that takes better advantage of the in-memory nature of database hosting and without the limitations associated with a disk-based model.

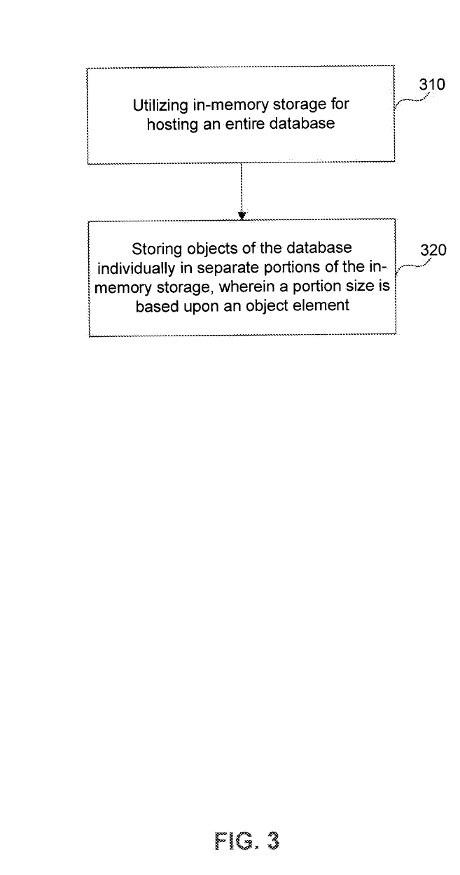

FIG. 3 illustrates a block diagram of an overall approach for optimizing data storage utilization of an in-memory database in a database management system in accordance with embodiments of the invention. The process includes utilizing in-memory storage for hosting an entire database (block 300). By way of example, similar to that described in “Managing Data Storage as an In-memory Database in a Database Management System”, an in-memory storage cache is able to be configured through a stored procedure for cache configuration to create, drop, or modify named caches e.g., sp_cacheconfig interfaces with ‘inmemory_storage’ as the cache type and with ‘none’ as the replacement strategy, and with specification of a cache size, in accordance with an embodiment. In contrast to “Managing Data Storage as an In-memory Database in a Database Management System”, no disk init is utilized and creation of an in-memory database through a create in-memory database command needs the size of the database and optionally a cache name but need not take any device options.

Objects of the database are stored individually in separate portions of the in-memory storage, wherein a portion size is based upon an object element size (block 310). Preferably, each object in the database, like a table, index, etc., is assigned a portion based on the requirement of the object size. The system tables, depending upon the nature of usage, can either be stored together or placed in individual small portions of their own. Identification and association of separate portions to tables and indices on the table allows for ease of operations, such as drop, create, etc. In an embodiment, a portion is a contiguous section of the in-memory storage and has a size that is specified when creating the object element. When the portion allocated to an object is full, a new portion is allocated (e.g., of a server-determined size, such as set by a user), and the portion maps are updated, as is well understood in the art.

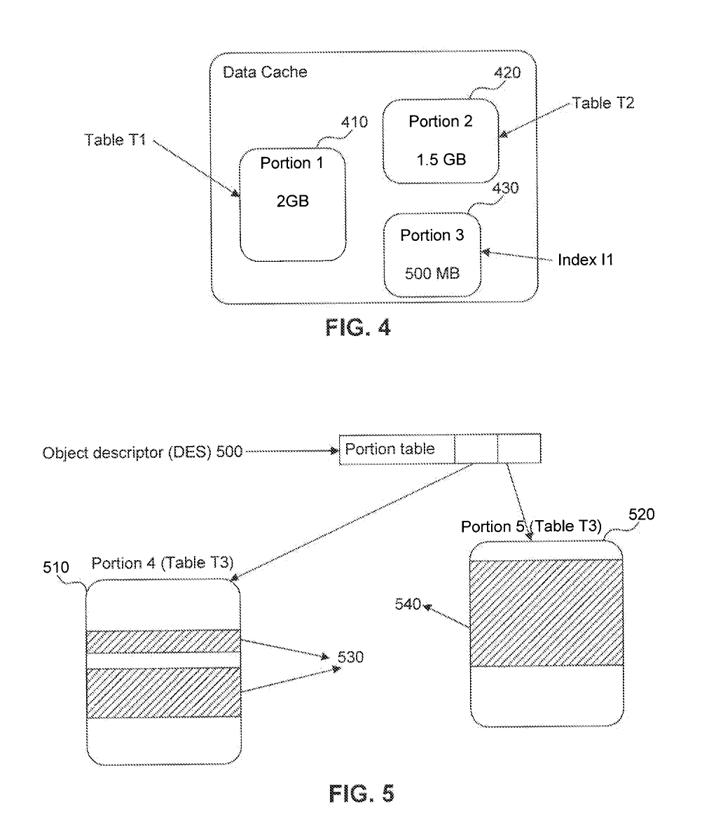

FIG. 4 illustrates an example block diagram representation of a data cache organized in accordance with an embodiment of the invention. As shown, the data cache 400 includes three objects, Table T1, Table T2, and Index I1 created as three separate respective portions, a portion 410 having a designated size of 2 gigabytes (2 GB), a portion 420 having a designated size of 1.5 GB, and a portion 430, having a designated size of 500 megabytes (MB). By way of example, the typical syntax for a DDL command for “create table” is modified to specify the portion, along with the size of the portion, either using a default table size or according to an anticipated size of the table. Once created, a new portion identifier is assigned to the portion, and the table is initialized.

Suitably, a global portion descriptor table keeps track of all portions allocated and their use by different objects, and can be used during database-wide operations, like database dump, etc. The meta-data of an object includes its portion descriptor table, which can be as simple as an array. The portion descriptor includes the portion identifier (id) and the size, and points to the starting memory location of the portion. FIG. 5 illustrates an example of an object descriptor (DES) 500 that includes pointers to portions 510 and 520 allocated to object table T3.

Further illustrated in FIG. 5 are free spaces 530 and 530 that result as operations occur and changes occur to the objects. Thus, as rows are added and deleted from a table in a portion, for example T3, the portion breaks up and holes are created. Heap memory management techniques are used to track either the free space or used space in the portion, as is commonly understood in the art. Further, executing a drop table command results in removal of the portion from the memory and an indication of the space thus accrued as “free” for return to a global free space pool (i.e., a list of free contiguous blocks of memory). The descriptor table may include information about the free space, such as the free space percentage of the portion.

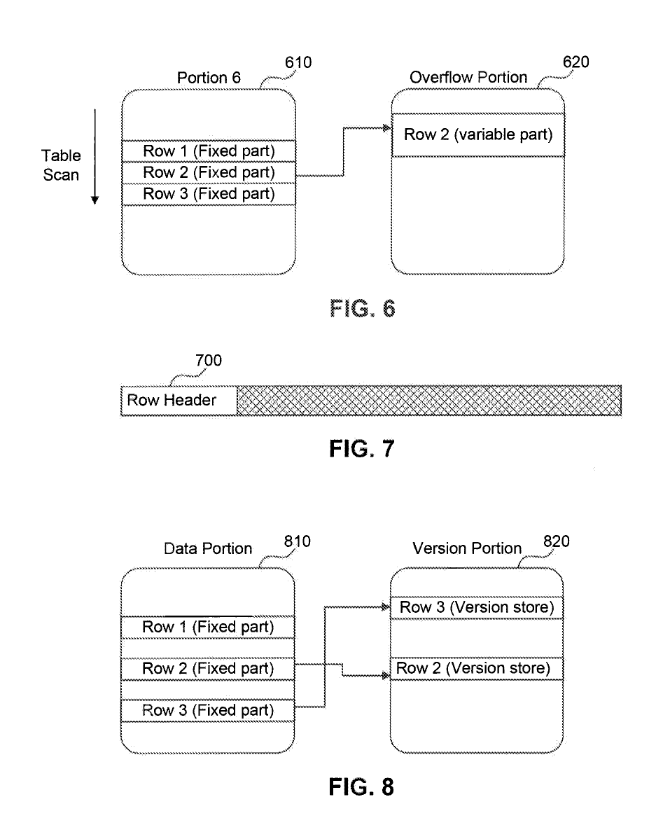

For a table object, the data rows in a portion are organized as being of a fixed size, and any difference in the size of the row, (ones with variable length columns, such as for varchars or text, or blobs), have a separate overflow portion, as represented by portion 610 and an overflow portion 620 in the example diagram of FIG. 6. A field in the row can provide a pointer to a memory location into the forwarded-row portion and also identify the size. Should the main row be deleted, the forwarded row space is released into the free space pool of that portion. The number of such overflow portions is decided by the system depending upon the nature and size of overflow, and various optimization techniques can be employed to manage each type of overflow portions like text, blob, etc.

In an embodiment, each row has a leading header 700 (e.g., a byte) for meta-data, as shown in row representation in FIG. 7. The meta-data supports physical operations on the row to allow increased access concurrency, such as by way of a set of bits to indicate that the row is being read or modified or not being used, which tasks can synchronize on for physical operations. Committed operation indicator(s) (like an uncommitted delete, insert, etc) which may be needed for certain scanners, such as SR (serialized) scanners in an ASE environment, can be included in the header. Modification of the header bits suitably occurs using a basic test-and-set instruction on the header, which provides more efficiency than a spinlock. Thus, the data locking is controlled at row-level (effectively the tables are DOL—row locked tables) with the lock records for row-level locks carrying the row id. Additionally, the entire portion or selective parts of the object in terms of the portion (for operations such as compaction, reorg, etc.) can be locked, as is commonly understood in the art.

This organization helps in operations like table scan that go through each and every portion that belongs to the object row-by-row. With the row header identifying whether it is a valid row, movement from one row to the next occurs easily by adding the fixed offset to the row size (e.g., by using a call to a getnext API in an ASE environment), and avoids having to find the start of the next row through another memory indirection. Thus, table scans are faster, since they do not have to go through the page manager to identify the set of pages that belong to the object and then go through each page after physically locking (latching) it.

In order for the table scan to be able to avoid chunks of memory that are free, a special row is inserted at the end of the valid section of rows and points to the next valid row in the portion (i.e., acting as a pointer) to speed up operations. When the end of the portion is reached, the scan moves to the first row of the next portion. A call to a qualification routine, e.g., qualrow, can be used to identify (using search arguments (SARGs)) if the next row qualifies. This qualification can be embedded into getnext, such that all the rows that do not qualify are skipped and the next qualified row is returned, for every invocation, as is well understood by those skilled in the art.

As the entire database fits in-memory, hash indices are utilized to provide access the data for point queries. The hash value on the index key points to a starting memory location (in the index portion) from where to get the pointers to the memory containing the data rows. Further, for an insert operation, a free location is picked from the portion, and the row is inserted at that point. The index, if any, is updated accordingly with the memory location of the row.

Tree-based indices, like binary trees, are useful in answering range queries. To support such indices, in an embodiment, the portion is organized such that the rows are balanced in correspondence with nodes of an index tree to prevent skew of the index tree. Such an organization is simple and can be as straightforward as maintaining a bit map of fixed-size sets of rows used/unused in the portion. In this manner, the portion approach doesn't preclude such an implementation or make it complex. Overflow (in the case of clustered indices where the related data has to be co-located) can be handled by having the stub to the next memory location where the subsequent rows are stored in memory. Further, split and shrink of index row sets in a tree-based index can be handled by blocking access to those row sets through the header information in the portion which tracks the row sets, as is commonly understood in general index management. As can be readily appreciated, the lack of pages and associated mechanism of the traditional disk-based database management system results in increased performance speed for queries, inserts, and deletes, even in the presence of indices, by removing the need to physically lock (latch) pages.

In an embodiment, to support a lockless protocol, a versioned row is identified from the row header, and a separate portion (e.g., on a table level) holds the versions of the rows, typically called the “version store” whose format can be different from the row format of the base rows, as illustrated by the example block diagram of data portion 810 and version portion 820 in FIG. 8. Similar to the page-based model, the original row points to the location where the version-store is located (in the form of a portion and row number within that portion). Maintenance of versions of rows with routing of transactions to different versions reduces locking/contention, e.g., rows can be maintained for write/write (once a write version is created, subsequent writers have to wait) or write/read (all readers can read a version until the write is committed) purposes, as is well appreciated by those skilled in the art.

For data recovery purposes, in an embodiment, logging no longer needs allocation, but rather, the end of the log is the last free offset in the portion, and logging is a fast operation that simply pushes the set of log records into the memory and updates the free offset. The common concept of pinning is removed completely from the system. When a row is modified or inserted, a log record is generated and simply added to the log portion. Further, log records contain references to data in re-locatable format (i.e., the offset of the data item from the start of the portion memory). Only the relative row-number within the portion is tracked, and depending upon where the portion is actually loaded, the actual offset is computed to find the row. In this manner, wherever the portion is loaded, the log records can be replayed and the data recovered.

With the described embodiments of the invention, the lower layers of page/buffer/cache management, which are primarily useful for a disk-based database system, are removed. Traditionally, if memory is small and data doesn't fit in it, some of the data must be stored on the disk to pave way for other data to be brought into the cache, and paging the memory helps to deal with data in replaceable blocks, so that blocks of interest are moved out to the disk and moved in to memory as required. The move to an in-memory database, where it is assumed that the entire data of the database fits into the memory, allows most of the overhead of buffer cache and page management to be avoided, which benefits in terms of increased throughput of transactions. The physical operations on rows are much faster as the heavy-weight page latching is replaced, as described herein, by synchronization using bits in the row header. While latches serialize access to different rows in the same page in a page-based model, the portion-based model of the inventive embodiments allow simultaneous parallel access to rows. Further, the avoidance of buffer structures, etc., benefits in terms of space. In addition, replication readily occurs to another in-memory database using a portion scheme of caching.

While the invention is described in some detail with specific reference to a preferred embodiment and certain alternatives, there is no intent to limit the invention to that particular embodiment or those specific alternatives. For example, the log may be provided on a separate portion. Further, the description presents methods that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server). Those skilled in the art will appreciate that modifications may be made to the preferred embodiment without departing from the teachings of the present invention.

What is claimed is:

1. A computer-implemented method for optimizing data storage and access of an in-memory database in a database management system, the method comprising:
utilizing in-memory storage for hosting an entire database; and
storing objects of the database individually in separate portions of the in-memory storage, wherein a portion size is based upon an object element size.

2. The computer-implemented method of claim 1 wherein the portion size comprises a multiple of a row size.

3. The computer-implemented method of claim 1 further comprising utilizing a row header to synchronize physical access to the rows and allow access concurrency.

4. The computer-implemented method of claim 1 further comprising utilizing separate portions for fixed and variable parts of an object element.

5. The computer-implemented method of claim 1 wherein a portion further comprises a contiguous section of the in-memory storage.

6. The computer-implemented method of claim 1 further comprising specifying the portion size when creating the object element.

7. A system for optimizing data storage and access in a distributed database system, the system comprising:
a database server including a memory for temporarily storing data objects; and
a database server engine forming a database hosted entirely in the memory, and storing data objects of the database individually in separate portions with a portion size based upon an object element size.

8. The system of claim 7 wherein the portion size comprises a multiple of a row size.

9. The system of claim 7 wherein the database server engine further utilizes a row header to synchronize physical access to the rows.

10. The system of claim 7 wherein the database server engine further utilizes separate portions for fixed and variable parts of an object element.

11. The system of claim 7 wherein a portion further comprises a contiguous section of the memory.

12. The system of claim 7 wherein the database server engine further utilizes a portion size specified when the object element is created.

13. A computer program product including a computer-readable medium having instructions stored thereon that, if executed by a computing device, cause the computing device to perform operations for optimizing data storage and access of an in-memory database in a database management system comprising:
utilizing in-memory storage for hosting an entire database; and
storing objects of the database individually in separate portions of the in-memory storage, wherein a portion size is based upon an object element size.

14. The computer program product of claim 13 wherein the portion size comprises a multiple of a row size.

15. The computer program product of claim 13 further comprising utilizing a row header to synchronize physical access to the rows.

16. The computer program product of claim 13 further comprising utilizing separate portions for fixed and variable parts of an object element.

17. The computer program product of claim 13 wherein a portion farther comprises a contiguous section of the in-memory storage.

18. The computer program product of claim 13 further comprising specifying the portion size when creating the object element.
